(19) United States
(12) Patent Application Publication
(10) Pub. No.: US 2023/0231257 A1
(43) Pub. Date: Jul. 20, 2023

(54) BATTERY PACK INCLUDING SURFACE PRESSURE MAINTAINING STRUCTURE

(71) Applicant: SEOYON E-HWA CO., LTD., Anyang (KR)

(72) Inventors: Sung Su KIM, Suwon (KR); Sang Hwan Park, Anyang (KR)

(21) Appl. No.: 18/048,442

(22) Filed: Oct. 21, 2022

(30) Foreign Application Priority Data
Jan. 14, 2022 (KR) 10-2022-0005757

(51) Int. Cl. H01M 50/291; H01M 50/204; H01M 50/242; H01M 10/48

(52) U.S. Cl. CPC H01M 50/291; H01M 50/204; H01M 50/242; H01M 10/482; H01M 10/486

(57) ABSTRACT

Provided is a battery pack including a surface pressure maintaining structure is provided, which includes a battery cell and a surface pressure maintaining part that is disposed on one side of the battery cell and applies a surface pressure to the battery cell, wherein the surface pressure maintaining part includes a pair of inclination members that are arranged between the battery cells, move in a horizontal direction to press the battery cell, and have spaces therein, and an insertion member that is inserted between the pair of inclination members, allows the inclination members to slide, and has a space therein.

### CROSS-REFERENCE TO RELATED APPLICATION

This application claims priority to and the benefit of Korean Patent Application No. 10-2022-0005757 filed on Jan. 14, 2022, the disclosure of which is incorporated herein by reference in its entirety.

### BACKGROUND

### 1. Field of the Invention

The present disclosure relates to a battery pack including a surface pressure maintaining structure in which a battery cell may be maintained at an appropriate surface pressure.

### 2. Discussion of Related Art

In general, a battery includes a cell, a module, and a pack. The battery cell is a basic unit of the battery and is formed in a cylindrical shape, a pouch shape, or an angular shape. The battery module is formed as an assembly in which a plurality of battery cells are disposed inside a frame. In the battery pack, a plurality of battery modules are disposed inside the frame, and the battery pack may be mounted on an electric vehicle requiring a high-capacity battery and used as a power source.

When the battery module is assembled, it is important to appropriately apply a surface pressure that is the pressure applied to the battery cell to maximize the lifetime of the battery cell. In particular, in the case of a pouch-type battery, when a use time is increased, as the degradation proceeds, the thickness is changed, and thus a surface pressure applied to the battery is increased. In this case, when the surface pressure of the battery is maintained at an appropriate level, the lifetime of the battery may be increased. In the related art, a method in which a pad is applied between batteries, the changed thickness of the battery cell is corrected, and the surface pressure is uniformly maintained has been used to take an advantage of this feature.

However, since the size of a module frame according to the related art is determined, a space in which the battery cell may be disposed inside the module frame is limited. Further, in a battery module according to the related art, since the tolerance of the battery cells is large, it is difficult to control the surface pressure of the battery cell. Further, it is difficult to apply a method of maintaining the surface pressure of the battery cell through the pad inserted between the batteries when a large number of battery cells are assembled. In the above method, since the pads should be arranged between each of the battery cells, a large amount of the pads are required, and a structure is difficult to design.

### SUMMARY OF THE INVENTION

The present disclosure is directed to providing a battery pack including a surface pressure maintaining structure in which a surface pressure of a battery cell may be maintained appropriately.

However, technical problems to be achieved by embodiments of the present disclosure are not necessarily limited to the above-described technical problems. Other technical problems that are not described may be clearly understood by those skilled in the art to which the embodiments of the present disclosure pertain from the other description of the specification such as the detailed description.

According to an aspect of the present disclosure, there is provided a battery pack including a battery cell, and a surface pressure maintaining part that is disposed on one side of the battery cell and applies a surface pressure to the battery cell, wherein the surface pressure maintaining part includes a pair of inclination members that are arranged between the battery cells, move in a horizontal direction to press the battery cell, and have spaces therein, and an insertion member that is inserted between the pair of inclination members, allows the inclination members to slide, and has a space therein.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic view before a battery pack according to a first embodiment of the present disclosure is assembled;

FIG. 2 is a schematic view after the battery pack illustrated in FIG. 1 is assembled;

FIG. 3 is an enlarged view of a surface pressure maintaining part and a module case illustrated in FIG. 1;

FIG. 4 is a cross-sectional view of a battery pack according to a second embodiment;

FIG. 5 is a cross-sectional view of a battery pack according to a third embodiment; and

FIG. 6 is a cross-sectional view of a battery pack according to a fourth embodiment.

### DETAILED DESCRIPTION OF EXEMPLARY EMBODIMENTS

Hereinafter, embodiments of the present disclosure will be described with reference to the accompanying drawings. The following embodiments may be provided more completely to describe the present disclosure to those skilled in the art. However, the following embodiments are provided to help the understanding of the present disclosure, and the technical spirit of the present disclosure is not necessarily limited to the following embodiments. Further, detailed descriptions that make the subject matter of the present disclosure unclear or correspond to the well-known configurations will be omitted.

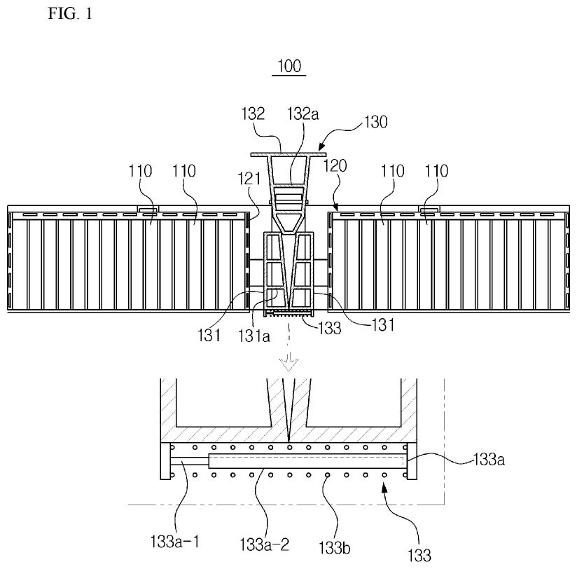

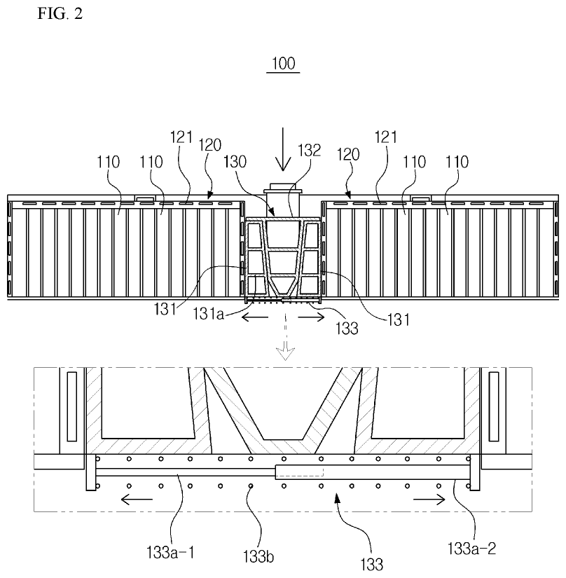

FIG. 1 is a schematic view before a battery pack according to a first embodiment of the present disclosure is assembled. FIG. 2 is a schematic view after the battery pack illustrated in FIG. 1 is assembled.

Referring to FIGS. 1 and 2, in a battery pack 100 according to the present embodiment, a plurality of battery cells 110 are arranged, and a swelling phenomenon in which the volume of the battery cell 110 is expanded due to repeated use may occur. The battery pack 100 according to the present embodiment may appropriately maintain the surface pressure of the battery cell 110 even when the volume of the battery cell 110 is expanded. In detail, the battery pack 100 may include the battery cell 110, a module case 120 in which the plurality of battery cells 110 are arranged, and a surface pressure maintaining part 130 for maintaining the battery cell 110 at an appropriate surface pressure. The battery pack 100 according to the present embodiment may appropriately maintain the surface pressure even when the volume of the battery cell 110 is changed, thereby improving the lifetime of the battery cell 110.

Hereinafter, each of the components will be described in more detail.

The battery cell 110 may be formed in a cylindrical shape, a pouch shape, or an angular shape. The plurality of battery cells 110 may be arranged inside the module case 120 to constitute the battery pack 100. Alternatively, the plurality of battery cells 110 may be arranged in the battery pack 100 without the module case 120 to form the battery pack 100 in a cell-to-pack structure. The battery cell 110 needs to maintain an appropriate pressure to maintain a capacity and a lifetime. In this case, a swelling phenomenon in which the battery cell 110 is expanded due to repeated use occurs, the surface pressure applied to the battery cell 110 is changed, and thus the capacity and the lifetime can be reduced.

The module case 120 may have a space therein, and the plurality of battery cells 110 may be arranged inside the module case 120. In detail, the module case 120 may include a buffer protrusion 121 that may cope with the expansion of the battery cell 110. The plurality of module cases 120 may be arranged in the battery pack 100, and thus the battery pack 100 may be more easily configured than a case in which the battery cell 110 is disposed in the battery pack 100 one by one.

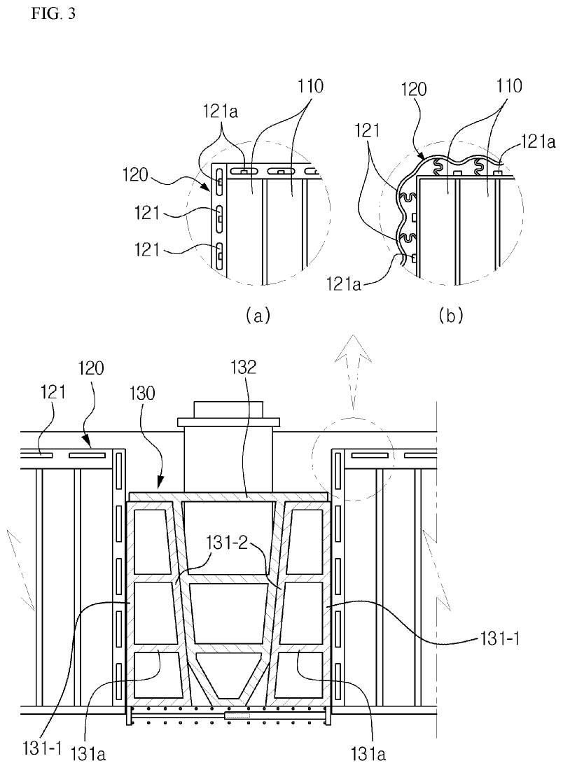

Meanwhile, FIG. 3 is an enlarged view of a surface pressure maintaining part and a module case illustrated in FIG. 1.

Referring to FIG. 3, the buffer protrusion 121 may be disposed around the module case 120 and may be fluidly pressed or unpressed depending on the change in the volume of the battery cell 110. Referring to FIG. 3A, the buffer protrusion 121 may be formed as a circular protrusion including a hollow therein. Preferably, in the buffer protrusion 121, circular protrusions may be consecutively disposed along a periphery of the module case 120. The buffer protrusion 121 may be disposed between the surface pressure maintaining part 130 and the battery cell 110 and may be pressed and unpressed as the volume of the battery cell 110 is changed.

FIG. 3B is another modification of the buffer protrusion 121 illustrated in FIG. 3A. In the buffer protrusion 121 illustrated in FIG. 3B, a plate-shaped member that may serve as an elastic member and may be formed in a zigzag shape may be disposed inside a curved member that is convex outward or inward. That is, even in the modification of the buffer protrusion 121, the hollow is disposed, and thus the buffer protrusion 121 may be pushed and pressed depending on the change in the volume of the battery cell 110.

As needed, the buffer protrusion 121 may include a sensor unit 121a. The sensor unit 121a may be disposed inside the buffer protrusion 121 to detect the change in the volume or the temperature of the battery cell 110. The sensor unit 121a may detect swelling or overheating of the battery cell 110 and transmit detected information to a controller (not illustrated), and thus a user can easily identify a state of the battery cell 110. For example, when the battery cell 110 is excessively expanded or overheated, the sensor unit 121a generates an alarm inside the vehicle. That is, the sensor unit 121a may be disposed to allow a user to check the battery cell 110 at an appropriate time.

Meanwhile, the surface pressure maintaining part 130 according to the present embodiment may be disposed on one side of the battery cell 110 or the module case 120. The surface pressure maintaining part 130 may be disposed to maintain the surface pressure of the battery cell 110 even when the volume of the battery cell 110 is changed. Preferably, the surface pressure maintaining part 130 may be disposed inside the battery pack 100. Since the surface pressure maintaining part 130 allows the battery cell 110 or the module case 120 to be disposed between the surface pressure maintaining part 130 and a case (not illustrated) of the battery pack 100, the battery cell 110 can be simply installed inside the battery pack 100.

In detail, the surface pressure maintaining part 130 may include inclination members 131 that are slidable in a horizontal direction, an insertion member 132 inserted between the inclination members 131, and a sliding portion 133 that guides paths of the inclination members 131. The surface pressure maintaining part 130 may appropriately maintain the surface pressure of the battery cell 110 depending on the expansion of the battery cell 110. Further, the surface pressure maintaining part 130 is formed in a simplified structure and does not occupy a large space, and since an available space is formed inside the battery pack 100, the available space can be easily utilized.

The pair of inclination members 131 may be arranged between the battery cells 110 or the module cases 120. The inclination member 131 may be disposed to move in a horizontal direction to press the battery cell 110 so that the battery cell 110 may have an appropriate surface pressure. Further, the inclination member 131 is formed to have a space therein, and thus the available space may be utilized by arranging electronic units inside the inclination member 131.

In detail, the inclination member 131 may include a first surface 131-1 in contact with the battery cell 110 or the module case 120 and a second surface 131-2 in contact with the insertion member 132. The first surface 131-1 may be formed to correspond to a contact surface of the battery cell 110 or the module case 120 or may be formed as a plate-shaped member perpendicular to the ground. The second surface 131-2 may have an inclination portion such that the area is reduced toward the lower side. Preferably, the second surface 131-2 may be formed in a shape corresponding to an inclination surface of the insertion member 132, and the insertion member 132 may be inserted between the pair of inclination members 131 along an inclination portion of the second surface 131-2.

In detail, the inclination member 131 may include a frame portion 131a disposed inside the inclination member 131 in a horizontal direction.

The frame portion 131a may be disposed inside the inclination member 131 in a horizontal direction and support the inclination member 131 against pressure. The frame portion 131a may be formed in a bar shape, may be disposed in a mesh-like shape inside the inclination member 131, and may be disposed to prevent the inclination member 131 from being deformed by the pressure of the battery cell 110. That is, the frame portion 131a may have a space inside the inclination member 131 to utilize the inner space and may be disposed to support the inclination member 131 without being deformed by an external pressure.

Meanwhile, the insertion member 132 may be inserted between the pair of inclination members 131 to slidably move the inclination members 131. Further, similar to the inclination members 131, the insertion member 132 may have a space therein, and the available space may be utilized by arranging electronic units inside the insertion member 132.

In detail, the insertion member 132 may be formed in a column shape and may be formed such that an upper end is identical or similar to that of the second surface 131-2 of the inclination member 131. The insertion member 132 may support the pair of inclination members 131. Meanwhile, a lower end of the insertion member 132 may be formed to have a narrower area than the upper end, and thus the insertion member 132 can be easily inserted between the pair of inclination members 131. As needed, the upper end and the lower end of the insertion member 132 may be arranged in reverse with respect to those described above.

Preferably, a pressing member (not illustrated) that may press the insertion member 132 may be disposed on an upper side of the insertion member 132, and thus the insertion member 132 may be disposed between the inclination members 131 without being separated therefrom. Alternatively, an upper cover (not illustrated) of the battery pack 100 may be formed in contact with the upper side of the insertion member 132 to press the insertion member 132. When the upper cover (not illustrated) is removed, the pressing of the insertion member 132 is released, and thus the insertion member 132 can be easily removed.

In detail, the insertion member 132 may include a frame portion 132a disposed inside the insertion member 132 in a horizontal direction.

The frame portion 132a may be disposed inside the insertion member 132 in a horizontal direction and support the insertion member 132 against pressure. The frame portion 132a may be formed in a bar shape and disposed inside the insertion member 132 in a mesh-like shape. The frame portion 132a may be disposed to prevent the insertion member 132 from being deformed by the pressure of the battery cell 110. That is, the frame portion 132a may have a space inside the insertion member 132 to utilize the inner space and may be disposed to support the insertion member 132 without being deformed by an external pressure.

Meanwhile, the sliding portion 133 may be disposed below the inclination member 131 and guide a path through which the inclination member 131 moves. In detail, the sliding portion 133 may include a support bar 133a connecting the pair of inclination members 131 and an elastic portion 133b disposed outside the support bar 133a. When the inclination member 131 moves in a horizontal direction, the sliding portion 133 may be disposed to prevent the inclination member 131 from being separated or misaligned in a direction different from a horizontal direction and to smoothly move the inclination member 131 in the horizontal direction within a predetermined path.

Preferably, when the insertion member 132 is extracted from the pair of inclination members 131, the sliding portion 133 may allow the pair of inclination members 131 to be released from being in contact with the battery cell 110 and to be spaced apart from each other. That is, the sliding portion 133 may be disposed to easily perform a maintenance operation of the battery cell 110.

The support bar 133a may be formed as a cylindrical member connecting the pair of inclination members 131. The support bar 133a may be formed as a pair of cylindrical members and may be disposed such that an inner member 133a-1 is inserted into an outer member 133a-2. As the support bar 133a slides according to the horizontal movement of the inclination member 131, the length of the support bar 133a may be variably increased or decreased. As needed, in the support bar 133a, a protrusion may be formed in the inner member 133a-1 or the outer member 133a-2, and a groove may be formed in the other member in which the protrusion is not formed. That is, the support bar 133a may be disposed in a manner in which the inner member 133a-1 and the outer member 133a-2 slide in a state in which the inner member 133a-1 and the outer member 133a-2 are partially coupled to each other. The inner member 133a-1 and the outer member 133a-2 may be arranged so that the support bar 133a is smoothly moved in a horizontal direction without being separated.

The elastic portion 133b may be disposed outside the support bar 133a. When the insertion member 132 is inserted between the pair of inclination members 131 and the support bar 133a is lengthened, the elastic portion 133b may also be lengthened. In contrast, when the insertion member 132 is extracted from the pair of inclination members 131, the elastic portion 133b may be elastically contracted. In this case, the elastic portion 133b may reduce the length of the support bar 133a so that a distance between the pair of inclination members 131 connected to the support bar 133a is reduced. That is, when the insertion member 132 is extracted from the inclination members 131, the elastic portion 133b allows the inclination members 131 to be spaced apart from each other without in contact with the battery cell 110. The elastic portion 133b allows the inclination member 131 to be spaced apart from the battery cell 110, and thus an operation related to the battery cell 110 can be easily performed without interference.

In description of a method of installing the battery pack 100, first, the battery cell 110 or the module case 120 is disposed between the case (not illustrated) of the battery pack 100 and the surface pressure maintaining part 130. After the battery cell 110 or the module case 120 is disposed inside the battery pack 100, the insertion member 132 is inserted between the pair of inclination members 131, and thus an appropriate surface pressure is provided to the battery cell 110. Thereafter, the upper cover (not illustrated) of the battery pack 100 is assembled, a pressure is applied to the upper end of the insertion member 132, and thus the insertion member 132 may be fixed without being separated.

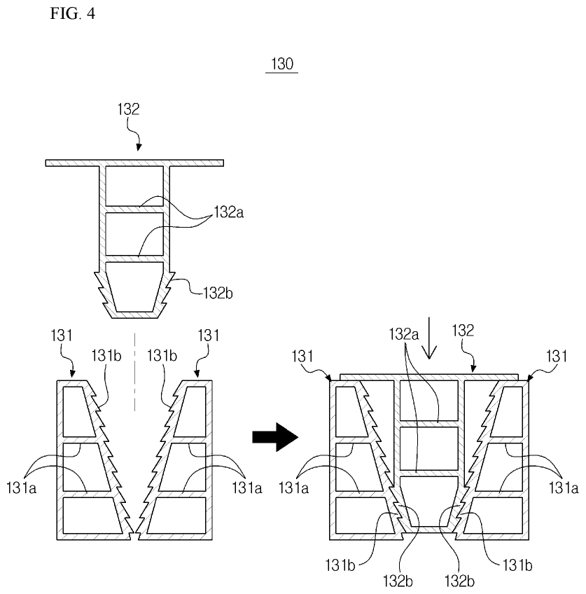

Meanwhile, FIG. 4 is a cross-sectional view of a battery pack according to a second embodiment.

Referring to FIG. 4, the surface pressure maintaining part 130 according to the present embodiment may include a first fastening protrusion 131b and a second fastening protrusion 132b. When the insertion member 132 is inserted between the inclination members 131, the first fastening protrusion 131b and the second fastening protrusion 132b may be arranged so that the insertion member 132 is not separated without a separate pressing member. That is, it is difficult to remove the first fastening protrusion 131b and the second fastening protrusion 132b after the insertion member 132 is inserted between the pair of inclination members 131. Thus, the first fastening protrusion 131b may be disposed when the battery cell 110 is not easily removed or changed after initial installation.

The first fastening protrusion 131b may have a plurality of protrusions and may be disposed on the second surface 131-2 of the inclination member 131. The first fastening protrusion 131b may be disposed to correspond to the second fastening protrusion 132b disposed in the insertion member 132.

The second fastening protrusion 132b may have a plurality of protrusions and may be disposed above or below the insertion member 132. Preferably, the second fastening protrusion 132b may be disposed on the inclination surface of the insertion member 132 having an inclination surface corresponding to the second surface 131-2 of the inclination member 131 and may be fixedly fitted to the first fastening protrusion 131b.

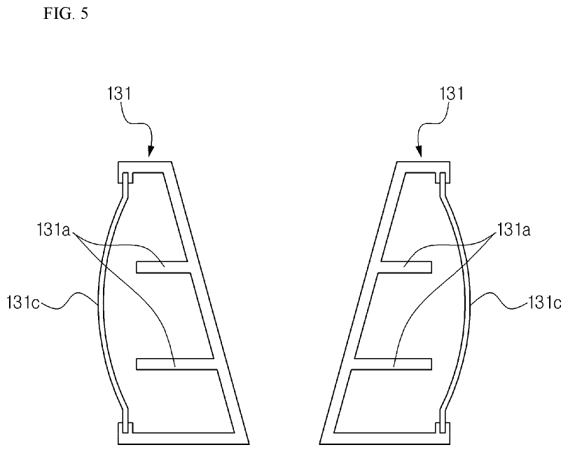

FIG. 5 is a cross-sectional view of a battery pack according to a third embodiment.

Referring to FIG. 5, the inclination member 131 according to the present embodiment may include an elastic protrusion 131c. The elastic protrusion 131c may be disposed on the first surface 131-1 of the inclination member 131 and may be variably deformed depending on the change in the volume of the battery cell 110. Preferably, the elastic protrusion 131c may be formed in a curved shape that is convex in a direction in which the battery cell 110 is disposed and thus may be retracted to the inside when the volume of the battery cell 110 is increased. The elastic protrusion 131c may be formed of an elastic material and provide an appropriate surface pressure to the battery cell 110 even when the volume of the battery cell 110 is increased.

As needed, the second surface 131-2 according to the present embodiment may have grooves formed on upper and lower sides thereof in a center direction. In detail, the second surface 131-2 may be formed in an assembly manner by retracting the elastic protrusion 131c having a convex portion into the grooves formed on the upper and lower sides.

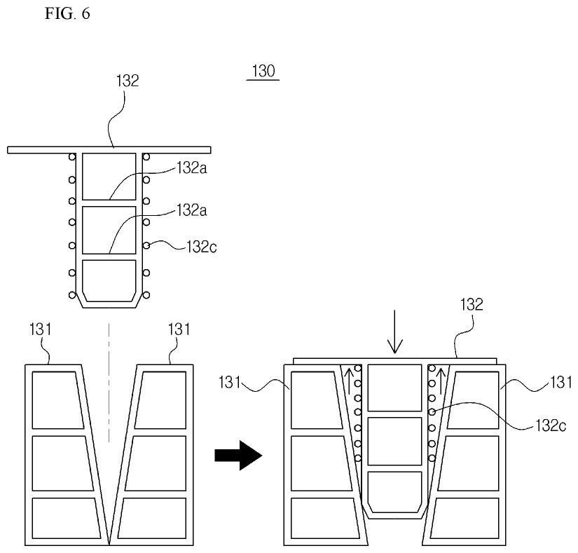

FIG. 6 is a cross-sectional view of a battery pack according to a fourth embodiment.

Referring to FIG. 6, the insertion member 132 according to the present embodiment may include a spring 132c. The spring 132c may be disposed around the insertion member 132 and provide a stronger surface pressure when the battery cell 110 is expanded. Preferably, in the insertion member 132 according to the present embodiment, the upper end thereof may be formed in a cylindrical shape formed perpendicular to the ground, and the lower end thereof may be formed in a truncated conical column shape that is narrowed toward the lower side.

In this case, the spring 132c according to the present embodiment may be retracted into the upper end of the insertion member 132, and thus the insertion member 132 may be inserted between the pair of inclination members 131. Thereafter, when the inclination member 131 is pushed to the center due to the expansion of the battery cell 110, the spring 132c may be further pressed to provide a stronger surface pressure to the battery cell 110.

As needed, the battery pack 100 according to the first embodiment may be simultaneously applied to the battery pack 100 according to the second, third, and fourth embodiments. Alternatively, the battery pack 100 according to the first embodiment and the battery pack 100 according to the second and third embodiments may be simultaneously applied, and the battery pack 100 according to the first embodiment and the battery pack 100 according to the third and fourth embodiments may be simultaneously applied.

As described above, the battery pack 100 according to embodiments of the present disclosure can maintain an appropriate surface pressure even when the volume of the battery cell 110 is changed. In the battery pack 100 according to the present disclosure, the surface pressure maintaining part 130 may be disposed between the battery cells 110 or the module cases 120 so that an appropriate surface pressure can be maintained in the battery cell 110.

Further, in the battery pack 100 according to embodiments of the present disclosure, by increasing the efficiency of using the inner space of the battery pack 100, more battery cells 110 per unit area can be arranged, and when electronic units are designed, the available space can be easily utilized. In the related art, since a surface pressure maintaining structure of the battery cell 110 should be disposed inside the battery pack 100, usage efficiency of the inner space of the battery pack 100 is reduced, and a structure is difficult to design.

In contrast, the battery pack 100 according to embodiments of the present disclosure includes the surface pressure maintaining part 130 for maintaining the surface pressure of the battery cell 110 inside the battery pack 100. Thus, in the battery pack 100 according to the present disclosure, the battery pack 100 in which the battery cell 110 is disposed and which includes the surface pressure maintaining structure may be completed. That is, in the battery pack 100 according to the present embodiment, since there is no need to retract a separate structure into the battery pack 100, the battery pack 100 can be simply configured, and the available space inside the battery pack 100 can be easily utilized.

In a battery pack according to embodiments of the present disclosure, an appropriate surface pressure can be maintained even when a volume of a battery cell is changed. In the battery pack according to the present disclosure, a surface pressure maintaining part is disposed between battery cells or module cases, and thus an appropriate surface pressure can be maintained in the battery cell.

Further, in the battery pack according to embodiments of the present disclosure, by increasing the efficiency of using an inner space of the battery pack, more battery cells per unit area can be arranged, and when electronic units are designed, an available space can be easily utilized.

However, the technical effects that can be obtained through the embodiments of the present disclosure are not necessarily limited to the above-described effects. Other technical problems that are not described may be clearly understood by those skilled in the art to which the present disclosure pertains from the other description of the specification such as the detailed description.

Hereinabove, embodiments of the present disclosure have been described. However, those skilled in the art can variously modify or change the present disclosure by adding, changing, and removing components without departing from the technical spirit of the present disclosure, and these modifications and changes are also included in the scope of the present disclosure.

What is claimed is:

1. A battery pack comprising:
a battery cell (110); and
a surface pressure maintaining part (130) that is disposed on one side of the battery cell (110) and applies a surface pressure to the battery cell (110),
wherein the surface pressure maintaining part (130) includes:
a pair of inclination members (131) that are arranged between the battery cells (110), move in a horizontal direction to press the battery cell (110), and have spaces therein; and
an insertion member (132) that is inserted between the pair of inclination members (131), allows the inclination members (131) to slide, and has a space therein.

2. The battery pack of claim 1, wherein the inclination member (131) includes:
a first surface (131-1) that is disposed as a surface in contact with the battery cell (110) or a module case (120) in which the battery cell (110) is disposed and is formed in a shape corresponding to a contact surface of the battery cell (110) or the module case (120); and
a second surface (131-2) that is disposed as a surface in contact with the insertion member (132) and has an inclination portion such that an area is reduced toward a lower side.

3. The battery pack of claim 1, further comprising a module case (120) in which a plurality of battery cells (110) are arranged,
wherein the module case (120) includes a buffer protrusion (121) that is disposed around the module case (120), has a hollow therein, and is pressed or unpressed depending on a change in volume of the battery cell (110).

4. The battery pack of claim 3, wherein the buffer protrusion (121) includes a sensor unit (121a) that detects the change in the volume of the battery cell (110) or a temperature of the battery cell (110) and provides detected information to a user.

5. The battery pack of claim 1, wherein the inclination member (131) and the insertion member (132) include frame portions (131a, 132a) that are arranged inside the inclination member (131) and the insertion member (132) in a horizontal direction and support the inclination member (131) and the insertion member (132) against pressure.

6. The battery pack of claim 1, wherein the surface pressure maintaining part (130) further includes a sliding portion (133) that is disposed below the inclination member (131), guides a path through which the inclination member (131) moves, and supports the inclination member (131) so that the inclination member (131) does not escape from a movement path.
